(19) United States
(12) Patent Application Publication
(10) Pub. No.: US 2023/0072731 A1
(43) Pub. Date: Mar. 9, 2023

(54) SYSTEM AND METHOD FOR PANOPTIC SEGMENTATION OF POINT CLOUDS

(71) Applicants: Thomas Enxu LI, Mississauga (CA); Ryan RAZANI, Toronto (CA); Bingbing LIU, Beijing (CN)

(72) Inventors: Thomas Enxu LI, Mississauga (CA); Ryan RAZANI, Toronto (CA); Bingbing LIU, Beijing (CN)

(21) Appl. No.: 17/899,451

(22) Filed: Aug. 30, 2022

Related U.S. Application Data
(60) Provisional application No. 63/238,759, filed on Aug. 30, 2021.

(51) Int. Cl. G06K 9/62; G06T 9/00; G01S 17/89

(52) U.S. Cl. CPC G06K 9/622; G06K 9/6232; G06K 9/6257; G06T 9/00; G06K 9/6267; G01S 17/89

(57) ABSTRACT

A method and system for clustering-based panoptic segmentation of point clouds and a method of training the same are provided. Features of a point cloud that includes a plurality of points are extracted. Clusters of the plurality of points corresponding to objects from the features of the point cloud frame are identified. A subset of the plurality of points is selectively shifted using the features and the clusters of the plurality of points via a neural network that is trained to recognize a subset of points of objects that are closer to points of other objects than a distance between centroids of the corresponding objects and shift the subset of points away from the other objects.

### FIELD

The present application generally relates to systems and method for panoptic segmentation of point clouds.

### BACKGROUND

Scene understanding, otherwise referred to as perception, is one of the primary tasks for autonomous driving, robotics, and surveillance systems. Light Detection and Ranging (LIDAR) sensors are generally used for capturing a scene (i.e. an environment) of a vehicle, robot, or surveillance system. A LIDAR sensor is an effective sensor for capturing a scene because of its active sensing nature and its high resolution sensor readings.

A LIDAR sensor generates point clouds where each point cloud represents a three-dimensional (3D) environment (also called a “scene”) scanned by the LIDAR sensor. A single scanning pass performed by the LIDAR sensor generates a “frame” of point cloud (referred to hereinafter as a “point cloud frame”), consisting of a set of points from which light is reflected from one or more points in space, within a time period representing the time it takes the LIDAR sensor to perform one scanning pass. Some LIDAR sensors, such as spinning scanning LIDAR sensors, includes a laser array that emits light in an arc and the LIDAR sensor rotates around a single location to generate a point cloud frame; others LIDAR sensors, such as solid-state LIDAR sensors, include a laser array that emits light from one or more locations and integrate reflected light detected from each location together to form a point cloud frame. Each laser in the laser array is used to generate multiple points per scanning pass, and each point in a point cloud frame corresponds to an object reflecting light emitted by a laser at a point in space in the environment. Each point is typically stored as a set of spatial coordinates (X, Y, Z) as well as other data indicating values such as intensity (i.e. the degree of reflectivity of the object reflecting the laser). The other data may be represented as an array of values in some implementations. In a scanning spinning LIDAR sensor, the Z axis of the point cloud frame is typically defined by the axis of rotation of the LIDAR sensor, roughly orthogonal to an azimuth direction of each laser in most cases (although some LIDAR sensor may angle some of the lasers slightly up or down relative to the plane orthogonal to the axis of rotation).

Point cloud frames may also be generated by other scanning technologies, such as high-definition radar or depth cameras, and theoretically any technology using scanning beams of energy, such as electromagnetic or sonic energy, could be used to generate point cloud frames. Whereas examples will be described herein with reference to LIDAR sensors, it will be appreciated that other sensor technologies which generate point cloud frames could be used in some embodiments.

A LIDAR sensor can be one of the primary sensors used in autonomous vehicles or robots to sense an environment (i.e., scene) surrounding the autonomous vehicle. An autonomous vehicle generally includes an automated driving system (ADS) or advanced driver-assistance system (ADAS). The ADS or the ADAS includes a perception system that processes point clouds to generate predictions which are usable by other sub systems of the ADS or ADAS for localization of the autonomous vehicle, path planning for the autonomous vehicle, motion planning for the autonomous vehicle, or trajectory generation for the autonomous vehicle.

Both instance segmentation and semantic segmentation are two key aspects of understanding a scene (i.e., perception). More specifically, compared with detecting instances of object, semantic segmentation is the process of partitioning an image, or a point cloud obtained from a LIDAR, or alternative visual representation into multiple segments. Each segment is assigned a label or tag which is representative of the category that segment belongs to. Thus, semantic segmentation of LIDAR point clouds is an attempt to predict the category or class label or tag for each point of a point cloud. In the context of ADS or the ADAS, however, object detection or semantic segmentation is not totally independent. As a class label or tag for an object of interest can be generated by semantic segmentation, semantic segmentation can act as an intermediate step to enhance downstream perception tasks such as object detection and tracking.

Panoptic segmentation involves performing both instance segmentation (e.g. which individual object segmentation mask does a point belong to) and sematic segmentation (which semantic category does a point belong to).

The purpose of panoptic segmentation is to identify class labels for points in “stuff” classes and both class labels and instance identifiers for points in the “thing” classes. “Stuff” are defined as a class that includes uncountable objects, such as vegetation, roads, buildings, sidewalks, etc. “Things” are defined as a class that includes “countable objects”, such as pedestrians, other vehicles (or robots), and bicycles, motorcycles, etc.

Generally there are two different approaches for performing panoptic segmentation. The first approach for performing panoptic segmentation, referred to as a top-down (or proposal-based) approach, is a two-stage approach which starts with foreground object proposal generation and followed by further processing the object proposals to extract instance information which is fused with background semantic information. An example of a top-down approach for performing panoptic segmentation is described in “ Li, Yanwei, et al, “Attention-guided unified network for panoptic segmentation,” 2019 IEEE Conference on Computer Vision and Pattern Recognition (CVPR), 2019”.

A second approach for performing panoptic segmentation, referred to as a bottom-up (proposal-free) approach performs semantic segmentation and then groups the ‘thing’ points into clusters to achieve instance segmentation. Examples of a bottom-up approach is described in “A. Milioto, J. Behley, C. McCool and C. Stachniss, “LiDAR Panoptic Segmentation for Autonomous Driving,” 2020 IEEE/RSJ

International Conference on Intelligent Robots and Systems (IROS), 2020, pp. 8505-8512, doi: 10.1109/IROS45743.2020.9340837″ (hereinafter Milioto), shown in FIG. 1A, and “Hong, Fangzhou, et al. “LiDAR-based Panoptic Segmentation via Dynamic Shifting Network.”, 2021 IEEE Conference on Computer Vision and Pattern Recognition (CVPR), 2021” (hereinafter Hong), shown in FIG. 1B. Hong's solution is a dual-branch network where a first branch performs semantic segmentation and a second branch predicts center offsets for foreground points. A dynamic shifting module is followed after the instance branch to further refine the predicted instance centers.

The top-down approaches for panoptic segmentation of point clouds described above include object detectors that are used to propose regions of interest or instance information. These approaches are computationally inefficient as they require significant memory and computing resources to perform panoptic segmentation of point clouds.

Accordingly, there is a need for improved systems and methods for panoptic segmentation of point clouds.

### SUMMARY

In accordance with a first aspect of the present disclosure, there is provided a computer-implemented method for clustering-based panoptic segmentation of point clouds, comprising: extracting features of a point cloud that includes a plurality of points; identifying clusters of the plurality of points corresponding to objects from the features of the point cloud frame; and selectively shifting a subset of the plurality of points using the features and the clusters of the plurality of points via a neural network that is trained to recognize a subset of points of objects that are closer to points of other objects than a distance between centroids of the corresponding objects and shift the subset of points away from the other objects.

The computer-implemented method can further include: mapping the plurality of points in the clusters into voxels; for each voxel in which points of the clusters are located, determining a center of mass of at least regions extending from the voxel in each direction along at least two axes; and the selectively shifting can include processing the center of mass and features of each region to identify a center of mass for the voxel.

A neighborhood region of voxels within a range of the voxel can also be used to determine the center of mass for each voxel.

The extracting features can include encoding the point cloud, and the identifying can include decoding the encoded point cloud and, for every point in the clusters of the plurality of points, predicting an offset to shift the point to a centroid of the object.

For each voxel in which points of the clusters are located, the neural network can generate a weight for each region that is used to scale the center of mass of the region.

The regions can extend from the voxel in each direction along three axes.

A neighborhood region of voxels within a range of the voxel can also be used to determine the center of mass for each voxel.

In a second aspect of the present disclosure, there is provided a computing system for panoptic segmentation of point clouds, comprising: a processor; a memory storing machine-executable instructions that, when executed by the processor, cause the processor to: extract features of a point cloud that includes a plurality of points; identify clusters of the plurality of points corresponding to objects from the features of the point cloud frame; and selectively shift a subset of the plurality of points using the features and the clusters of the plurality of points via a neural network that is trained to recognize a subset of points of objects that are closer to points of other objects than a distance between centroids of the corresponding objects and shift the subset of points away from the other objects.

The instructions, when executed by the processor, can cause the processor to: map the plurality of points in the clusters into voxels; for each voxel in which points of the clusters are located, determine a center of mass of at least regions extending from the voxel in each direction along at least two axes; and wherein the selectively shift includes processing the center of mass and features of each region to identify a center of mass for the voxel.

A neighborhood region of voxels within a range of the voxel can also be used to determine the center of mass for each voxel.

During extraction of the features, the instructions, when executed by the processor, can cause the processor to encode the point cloud, and, during the identification of clusters, decode the encoded point cloud and, for every point in the clusters of the plurality of points, predict an offset to shift the point to a centroid of the object.

For each voxel in which points of the clusters are located, the neural network can generate a weight for each region that is used to scale the center of mass of the region.

The regions can extend from the voxel in each direction along three axes.

A neighborhood region of voxels within a range of the voxel can also be used to determine the center of mass for each voxel.

In a third aspect of the present disclosure, there is provided a method for training a system for panoptic segmentation of point clouds, comprising: extracting features of a point cloud that includes a plurality of points; identifying clusters of the plurality of points corresponding to objects from the features of the point cloud frame; and selectively shifting a subset of the plurality of points using the features and the clusters of the plurality of points via a neural network that is trained via supervision to recognize a subset of points of objects that are closer to points of other objects than a distance between ground-truth centroids of the corresponding objects and shift the subset of points away from the other objects.

The method can further comprise: mapping the plurality of points in the clusters into voxels; for each voxel in which points of the clusters are located, determining a center of mass of at least regions extending from the voxel in each direction along at least two axes; and the selectively shifting can include processing the center of mass and features of each region to identify a center of mass for the voxel.

A neighborhood region of voxels within a range of the voxel is also used to determine the center of mass for each voxel.

The extracting features can include encoding the point cloud, and the identifying can include decoding the encoded point cloud and, for every point in the clusters of the plurality of points, predicting an offset to shift the point to a centroid of the object.

For each voxel in which points of the clusters are located, the neural network can generate a weight for each region that is used to scale the center of mass of the region.

The regions extend from the voxel in each direction along three axes.

A neighborhood region of voxels within a range of the voxel can also be used to determine the center of mass for each voxel.

Other aspects and features of the present disclosure will become apparent to those of ordinary skill in the art upon review of the following description of specific implementations of the application in conjunction with the accompanying figures.

### BRIEF DESCRIPTION OF THE DRAWINGS

Reference will now be made, by way of example, to the accompanying drawings which show example embodiments of the present application, and in which:

FIGS. 1A and 1B show prior art systems for panoptic segmentation of point clouds.

FIG. 2 is a block diagram of various logical components of a system for clustering-based panoptic segmentation of point clouds according to an example embodiment of the present disclosure;

FIGS. 3A and 3B are flowcharts of a method performed by the system of FIG. 2 according to an example embodiment of the present disclosure.

FIG. 4A is a diagram of a voxelized foreground point cloud according to an example embodiment of the present disclosure.

FIG. 4B is a diagram of multi-directional kernels being applied to the voxelized foreground point cloud of FIG. 4A.

FIG. 4C is a diagram of a voxelized foreground point cloud after processing by the sparse multi-directional attention clustering module of the system of FIG. 2.

FIG. 4D shows a convolution with cross local spatial attention used by the system according to an example embodiment of the present disclosure.

FIG. 5 is a diagram of a centroid-aware repel loss according to an example embodiment of the present disclosure.

FIG. 6 is a diagram of a scenario where centroid-aware repel loss is zero.

FIG. 7 is a diagram of seven kernels applied in three dimensions according to an example embodiment of the present disclosure.

FIG. 8 is a flowchart of an alternative method of aggregating foreground points towards centroids of objects according to another embodiment.

FIG. 9 is a schematic diagram showing various physical and logical components of a computing system for clustering-based panoptic segmentation of point clouds according to an example embodiment of the present disclosure.

FIG. 10 shows various exemplary five-by-five kernels that can be employed in in panoptic segmentation approaches as described herein.

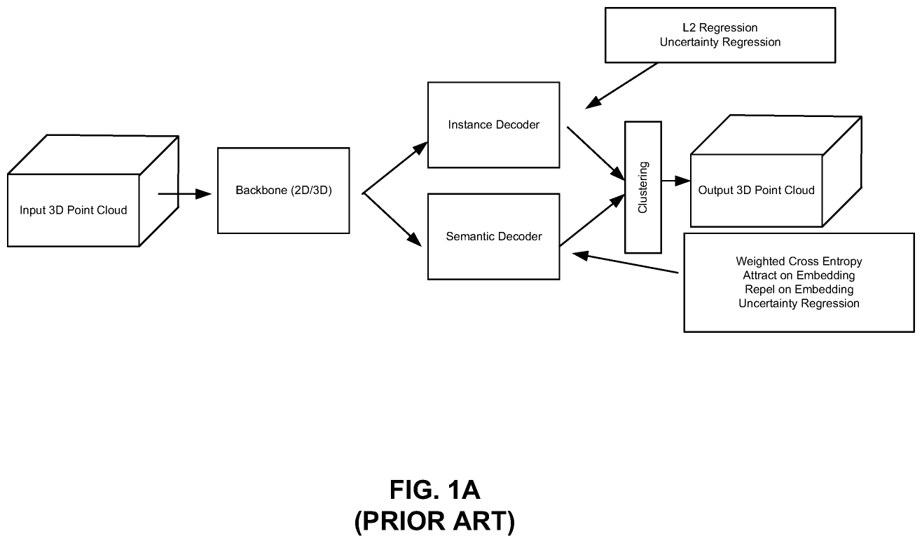

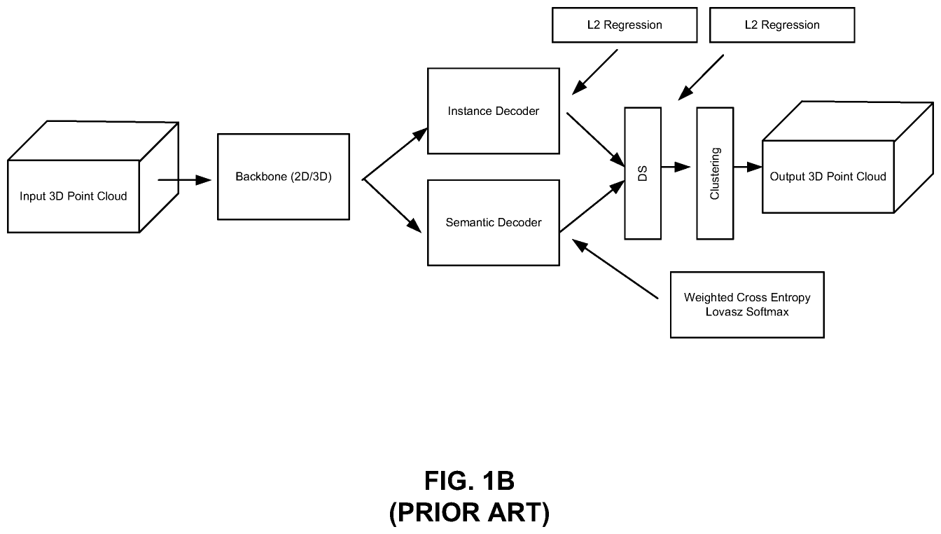

Similar reference numerals may have been used in different figures to denote similar components.

### DETAILED DESCRIPTION

The present disclosure is made with reference to the accompanying drawings, in which embodiments are shown. However, many different embodiments may be used, and thus the description should not be construed as limited to the embodiments set forth herein. Rather, these embodiments are provided so that this application will be thorough and complete. Wherever possible, the same reference numbers are used in the drawings and the following description to refer to the same elements, and prime notation is used to indicate similar elements, operations or steps in alternative embodiments. Separate boxes or illustrated separation of functional elements of illustrated systems and devices does not necessarily require physical separation of such functions, as communication between such elements may occur by way of messaging, function calls, shared memory space, and so on, without any such physical separation. As such, functions need not be implemented in physically or logically separated platforms, although such functions are illustrated separately for ease of explanation herein. Different devices may have different designs, such that although some devices implement some functions in fixed function hardware, other devices may implement such functions in a programmable processor with code obtained from a machine-readable medium. Lastly, elements referred to in the singular may be plural and vice versa, except wherein indicated otherwise either explicitly or inherently by context.

Herein is disclosed a novel centroid-aware repel loss approach for clustering that can effectively learn to separate different foreground points with the prior knowledge of ground-truth centroids, thus reducing the confusion of multiple instances in clustering.

In the present disclosure, the term “LIDAR” (also “LiDAR” or “Lidar”) refers to Light Detection And Ranging, a sensing technique in which a sensor emits laser beams and collects the location, and potentially other features, from light-reflective objects in the surrounding environment.

In the present disclosure, the term “point cloud” refers to a set of points captured via a LIDAR or another suitable device that form a point cloud frame. That is, the points in the point cloud are captured simultaneously or within a very short period of time and represent a single scene or view.

In the present disclosure, the term “point cloud object instance”, or simply “object instance” or “instance”, refers to a point cloud for a single definable object such, as a car, house, or pedestrian, which can be defined as a single object.

For example, typically a road cannot be an object instance; instead, a road may be defined within a point cloud frame as defining a scene type or region of the frame.

Panoptic segmentation is important for scene understanding in autonomous driving and robotics. The present disclosure describes systems, methods, devices, and computer-readable media for clustering-based panoptic segmentation of point clouds.

Prior clustering-based methods typically use the L2 difference of the ground truth center offset and the predicted center offset as the loss to back propagate.

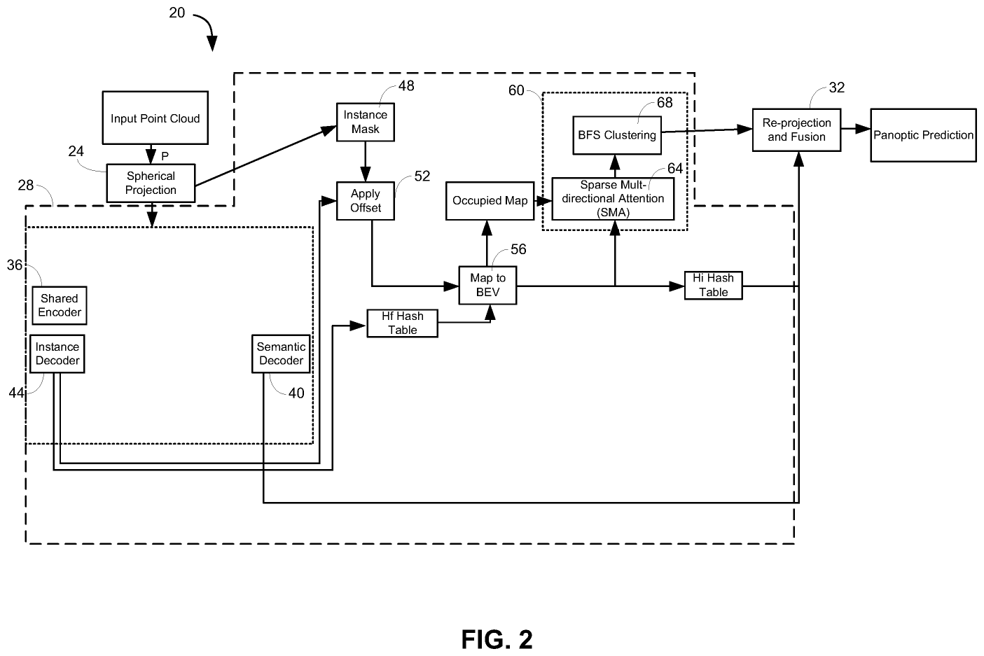

Referring to FIG. 2, a system 20 for clustering-based panoptic segmentation of point clouds is shown. The system 20 includes a projection module 24, a sparse multi-directional attention clustering network 28 (referred to as a SMAC-Seg network), and a panoptic fusion module 32. The SMAC-Seg network 28 includes an encoder 36, a semantic decoder 40, an instance decoder 44, an instance mask module 48, an offset module 52, a conversion module 56, and a sparse multi-directional attention and clustering (SMAC) module 60. The output of the encoder 36 is coupled to each of the semantic decoder 40 and the instance decoder 44 and is generally referred to as a “shared” encoder. In some embodiments, the encoder 36 is a convolutional neural network and the semantic decoder 40 and the instance decoder 44 are each de-convolutional neural networks (or transposed convolutional neural networks).

The sparse multi-directional attention and clustering module 60 includes a sparse multi-directional attention sub-module 64 and a clustering sub-module 68. The sparse multi-directional attention sub-module 64 is configured to learn to shift foreground points such that foregrounds points of the same instance object are close to each other and away from other instances. The knowledge learned is used to train a neural network for shifting foreground points of the same instance object. The clustering sub-module 68 is configured to run a clustering algorithm, such as Breadth First Search (BFS), HDBSCAN, or meanshift, on the shifted foreground points. The center regression is usually supervised by L2 difference of a learned center with the ground truth center.

The sparse multi-directional attention sub-module 64 is configured to refine clusters of foreground points to ensure the each instance cluster is aggregated towards a center of a cluster of foreground and away from other instances. Thus, the sparse multi-directional attention sub-module 64 enables the clustering sub-module 68 to run a clustering algorithm, such as BFS, much faster with a fixed radius. Moreover, the shifting of the foreground points are supervised using a centroid-aware repel loss and ground-truth centroids of instances, as opposed to the L2 regression loss to penalize a distance between each foreground point pair that does not belong to the same object instance of “things”. The centroid-aware repel loss allows the clustering sub-module 68 to effectively learn to separate different foreground points with the prior knowledge of ground-truth centroids, thus reducing the confusion of multiple instances during clustering.

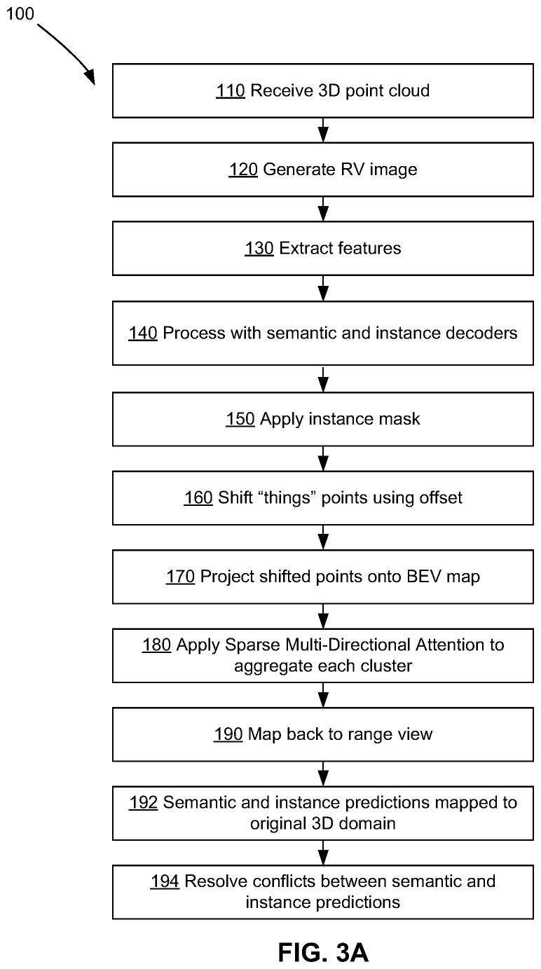

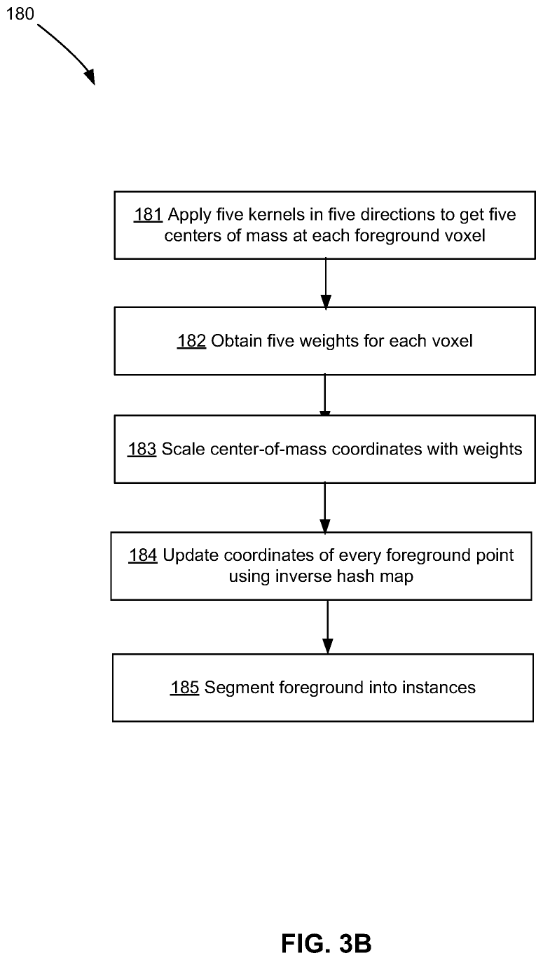

A method 100 performed by the system 20 of FIG. 2 will now be described with reference to FIGS. 3A and 3B. The system 20 receives a three-dimensional (3D) point cloud, denoted P, generated by LiDAR sensor (110). The point cloud P={x; y; z; r; Iₛₑₘ; I_{inS})ᵢ|i ∈ {1, . . . , N} where N is the number of points in the point cloud; (x, y, z) are the Cartesian coordinates in the reference frame centered at the LiDAR sensor; r is the measure of reflectance returned by a LiDAR beam. The projector 24 is configured to project the point cloud P using spherical transformation into a range view (RV) image, denoted as P ∈R^{H×W×C}^{ᵢ}, where H, W are the height and width of the range image and Cᵢ is the input features (Cartesian coordinates, remission and depth) (120).

The encoder 36, which may be a CNN, is configured to receive and extract features from the RV image and generate a feature map (otherwise referred to as a feature representation) of the RV image (130). The input RV is passed to the shared encoder 36 which includes a CLSA block followed by three Cross blocks and one residual bottleneck block to extract contextual and global features. The semantic decoder 40 and the instance decoder 44 are configured to predict semantic classes and instances, respectively (140). In particular, the semantic decoder 40 is configured to receive the down-sampled feature map from the encoder 36 and perform semantic segmentation on the feature map to generate a reconstructed RV image that includes predicted semantic classes for the points in the point cloud P. The reconstructed RV image has the same resolution as an input image, H×W. The semantic decoder 40 predicts semantic classes, denoted as Pₛₑₘ ∈ R^{H×W×C}^{_{cls}}, with C_{cls} number of classes, while the instance decoder predicts instances of “things” by regressing the 2D x,y offset P₀ ∈ R^{H×W×2}.

To further obtain instance IDs for the foreground, an instance mask is applied by the instance mask module 48 to filter the point cloud such that only the “things” points remain in the filtered RV image, denoted as Pₜₕ ∈ [symbol] ^{M×2}, where M is the number of remaining foreground points and 2 is the original x and y coordinates (150). Note that the mask is obtained from the ground truth semantic label during training and is computed from the predicted semantic label during inference. C is the filtered RV image with its original xy coordinates. F is its corresponding features from the instance decoder. C has a shape of (N, 2), and F has a shape of (N, f), where N is the number of foreground points and f is the number of features.

The offset module 52 is configured to receive the filtered RV image and generate an offset filtered RV image, denoted P_{S}, by using P_{O}, a learned 2D center offset of the corresponding foreground points from the instance decoder 34 and shifting them towards the object centers (160).

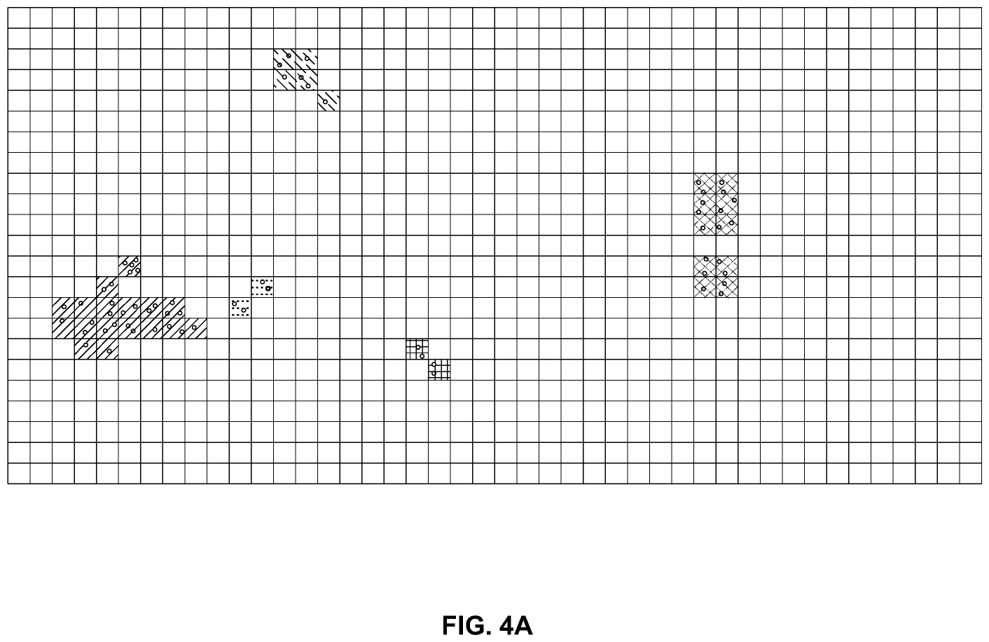

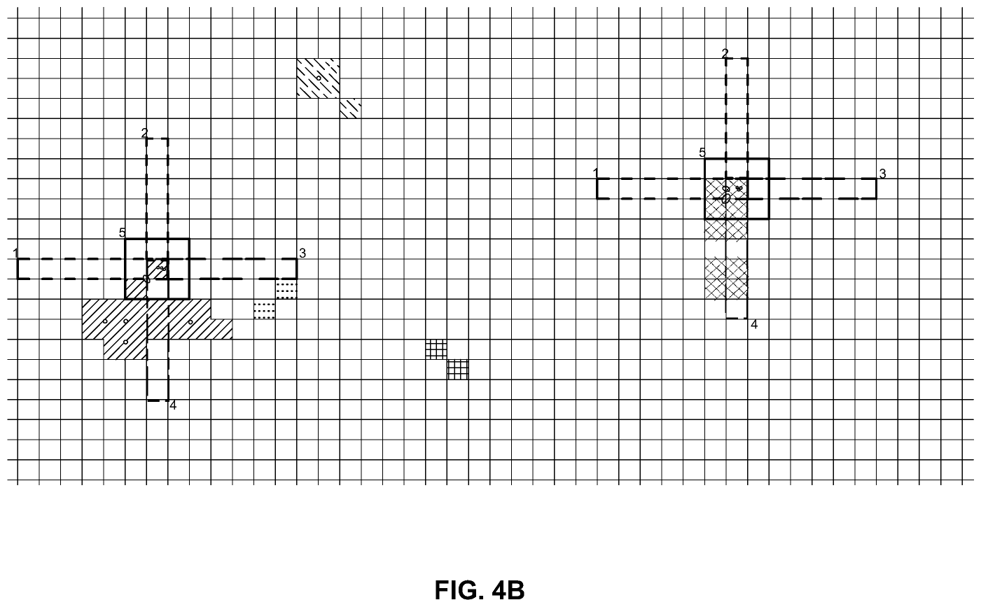

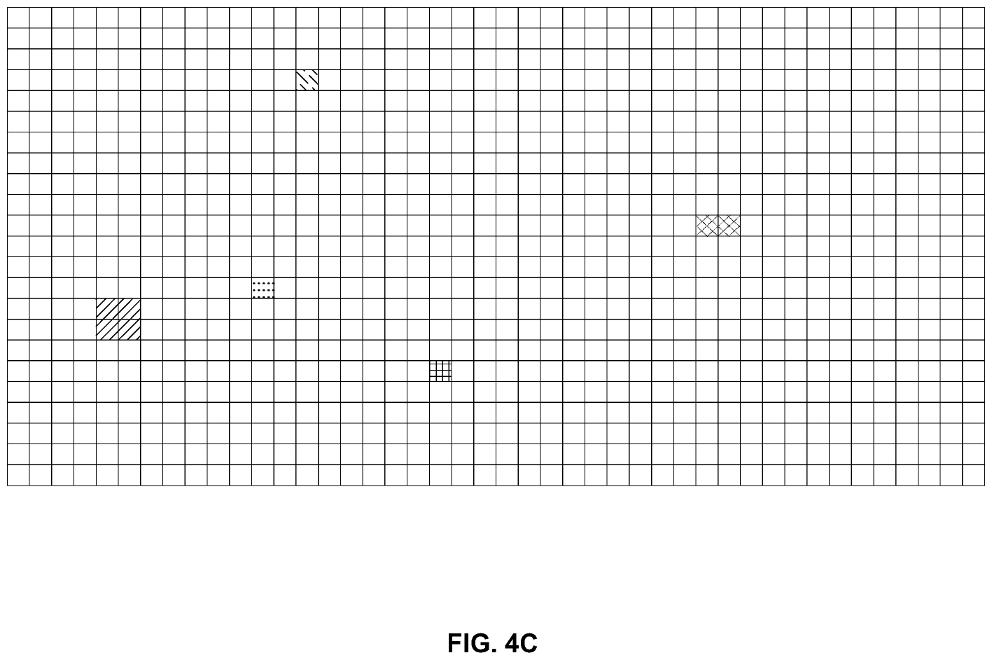

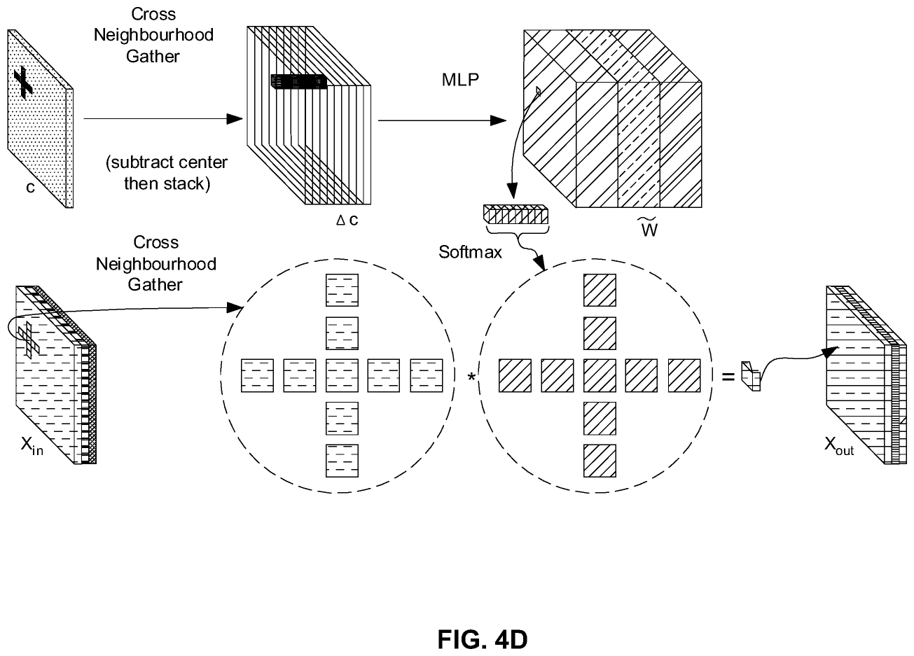

The conversion module 56 is configured to project, using shifted and discretized x and y coordinates, the offset filter RV image P_{S} into a bird's eye view (BEV) map, C_{bev} ∈ [symbol] ^{h×w×2} (170). h and w are the dimensions of the BEV map which are different than the dimensions of the filtered offset RV image using the shifted and discretized x and y coordinates as indices. The foreground point cloud with voxel size of (dₓ,d_{y}) is voxelized using its learned coordinate, Cₛ, dₓ and d_{y} are the grid size in x and y axis respectively. The projection of the offset filtered RV image Pₛ into a BEV map results in a binary occupancy mask, [symbol] ∈ [symbol] ^{h×w} to mark the occupied cells as valid entries. The resulting BEV map is alternatively said to be voxelized with unlimited depth along the z axis, or pillarized. At the same time, a hash table, H_{f}, is built to keep track of the features of the corresponding location in the BEV map with valid entries as well as another hash table, Hᵢ (i.e., an inverse mapping to devoxelize the point cloud), for their original indices in the RV image. In the case of multiple points being projected onto the same BEV location, the mean of the features of the projected points is used. The voxelized point cloud contains coordinates C_{D} and features F_{D} which are the mean coordinates and features of the points within the grid. In particular, C_{D} and F_{D} has a shape of (M, 2) and (M, C), where M is the number of voxels and C is the number of features, as shown in FIG. 4A. The points represent the shifted points in the point cloud.

The sparse multi-directional attention and clustering module 60 applies Sparse Multi-directional Attention (SMA) to aggregate each cluster in C_{bev} using attention weights obtained from its corresponding features from H_{f} (180). This is further detailed herein. BFS clustering with a radius of r is used on C_{f}, the BEV map generated as the output of SMA, to differentiate each object to thus obtain instance label \hat{P}ᵢₙₛ∈ [symbol] ^{h×w}. This is described further herein.

The instance label is mapped back to the range view using the hash table, Hi (190). Once the sparse multi-directional attention and clustering module 60 has generated semantic and instance prediction results, the panoptic fusion module 32 is configured to map the semantic and instance prediction results back to the original point with the index (u, v). At the same time, the panoptic fusion module 32 uses a K nearest neighbors (KNN) algorithm to post-process the output as the points very close to each other in the 3D space are refined to get the same instance and semantic label. The semantic and instance segmentation RV predictions are then mapped to the original 3D domain and are concatenated as panoptic predictions (192). Optionally, majority-voting is used to address any conflicts between semantic and instance predictions (194). The panoptic fusion module 32 is configured to resolve any conflicts between the predicted instance labels and semantic labels. When points are assigned same instance label but different semantic labels, a majority voting scheme is used to refine semantic labels within the same instance label.

The application of sparse multi-directional attention at 180 will now be described in further detail with respect to this embodiment.

The sparse multi-directional attention sub-module 64 is configured to receive an original coordinate map c (N, 2) on the xy plane and the original coordinate map's learned offset towards an instance centroid O (N, 2), where N is the number of foreground points in the received point cloud. The sparse multi-directional attention sub-module 64 is also configured to aggregate foreground points towards a ground-truth centroid of an object instance in the xy plane and aggregate away other object instances during supervised training.

At each foreground voxel, the sparse multi-directional attention sub-module 64 applies the following five kernels in five directions to get the five centers of mass [symbol] _{LEFT}, [symbol] _{RIGHT}, [symbol] _{UP}, [symbol] _{DOWN}, [symbol] _{CENTRE} (181). FIG. 4B shows the five kernels being applied to the points in the voxels of FIG. 4A. The left center of mass is computed as

$${\vec{C}}_{LEFT} [ i , j ] = \frac{1}{{P}_{LEFT , ij}} {\sum }_{( u , v ) {ϵΩ}_{LEFT}} {C}_{D} [ i + u , j + v ] ,$$

and the kernels extend to
Ω_{LEFT}: {(0,0), (0,−1), . . . , (0,−K)},
Ω_{RIGHT}: {(0,0), (0,1), . . . , (0,K)},
Ω_{UP}: {(0,0), (−1,0), . . . , (−K,0)},
Ω_{DOWN}: {(0,0), (1,0), . . . , (K,0)}, and
   Ω_{CENTRE}: v²(k), list of offsets in 2-dimensional hypercube centered at the origin, where P_{LEFT,ij} is the number of occupied voxels within the left neighborhood of voxel (i,j).

Next, the following five weights are obtained from a neural network in the form of a multilayer perceptron (MLP, shown in FIG. 4D, for each voxel using the five centers of mass and the average features of each of the voxels in the kernel regions (182):
wleft, Wright, wup, wdown, wcentre:=MLP (FD), and
   wleft, wright, wup, wdown, wcentre:=softmax(wleft, wright, wup, wdown, wcentre). The softmax( ) function scales these weights so that the total of the weights is one.

The sparse multi-directional attention sub-module 64 trains the MLP for shifting foreground points such that foregrounds points of the same instance object are close to each other and away from other instances.

A spatially adaptive feature extractor for range images is used by the sparse multi-direction attention and clustering module 60 to incorporate the local 3D geometry as shown in FIG. 4D. Specifically, the regular convolutions in the second half of the Diamond Block similar to that of M. Gerdzhev et al., “Tornado-net: multiview total variation semantic segmentation with diamond inception module,” in 2021 IEEE International Conference on Robotics and Automation (ICRA). IEEE, 2021 (hereinafter, Gerdzhev), are replaced with CLSA convolutions. A 2D convolution operation can be written as

xᵤ^{out}=[xᵤⁱⁿ*W]ᵥ_{²}_{(K)}=Σ_{i∈v}_{²}₍ₖ₎Wᵢxᵤ₊₁ⁱⁿ (1)

where u denotes the 2D index to locate each point in the feature map, W ∈ [symbol] ^{K×K×N}^{^{out}}^{×N}^{ⁱⁿ} is the kernel weight, shared among each sliding window, with Nⁱⁿ, N^{out} being the number of input and output feature channels respectively, V²(K) is the list of offsets in 2D square with length K centered at the origin. Here, it is desired that

W is adaptive to the geometry of each neighborhood, in particular, with attention built from the relative positions of the points. Formally, a 2D convolution with cross local spatial attention is introduced as follows:

xᵤ^{out}=[xᵤⁱⁿ*\tilde{W}ᵤ]_{N}_{²}_{(K)} (2)

\tilde{W}ᵤ=σ[w(∪_{i∈N}_{²}_{(K)}cᵤ₊₁−cᵤ)] (3)

where \tilde{W}ᵤ ∈ [symbol] ^{(2K-1)×N}^{^{out}}^{×N}^{ⁱⁿ}^{×H×W} is the spatially adaptive kernel weight computed from the relative geometric positions of the points within the cross-shaped neighborhood, w(.) is the PointNet model architecture introduced in C. R. Qi, “Pointnet: Deep learning on point sets for 3d classification and segmentation,” in Proceedings of the IEEE conference on computer vision and pattern recognition, 2017, cᵤ is the corresponding spatial coordinate feature of xᵤⁱⁿ (i.e., Cartesian xyz, depth, and occupancy), ∪ is the concatenation operator, σ denotes the softmax operation on the spatial dimension to ensure the attention weights in the neighborhood for each feature channel are summed up to 1, and N²(K) is a set of offsets that define the shape of a cross kernel with size of K (e.g., N²(3)={(−1, 0), (0, 0), (1, 0), (0, 1), (0, −1)}).

The CrossNet backbone includes 3 layers of cross blocks which are designed to capture multi-scale features, followed by a bilateral fusion to obtain rich information at each block. In particular, the input feature is first passed to a multi branch convolution layers and each branch further processes the features with convolution layers of different receptive field (followed by a Relu and a BatchNorm layer) to obtain fine-grained information. Next, a bilateral fusion module is applied on each branch to fuse the features of different resolution. Finally, all the feature maps are concatenated and their channel numbers are reduced through a final convolution layer for efficient processing.

The coordinates for the five centers of mass are scaled with the corresponding weights to generate a feature-dependent center of mass c_{f} for each voxel (183). In particular,
[symbol] _{f}:=w_{left}× [symbol] _{LEFT}+w_{right}× [symbol] _{RIGHT}+wᵤₚ× [symbol] _{UP}+w_{down}× [symbol] _{DOWN}+w_{centre}× [symbol] _{CENTRE}.
   FIG. 4C shows the scaled centers of mass of FIG. 4B.

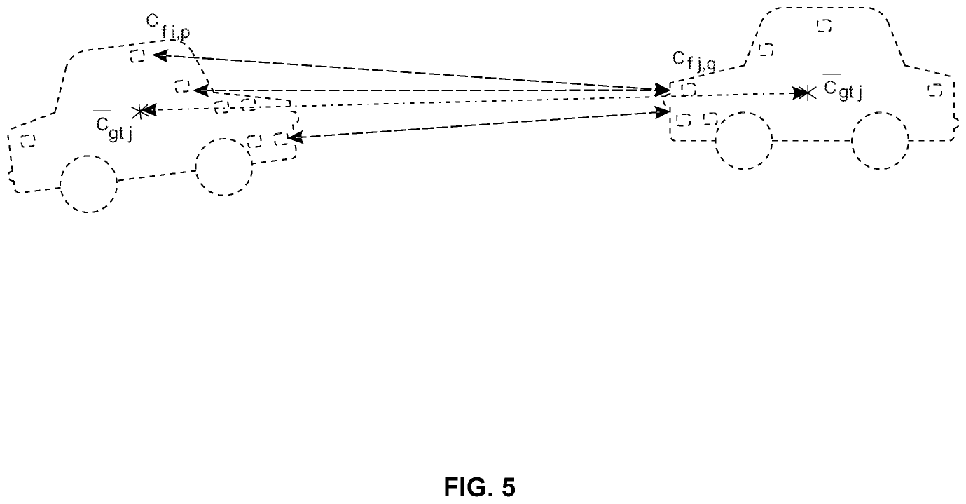

Note that the MLP, and thus c_{f}, is trained using supervision with ground-truth centroids using a centroid-aware repel loss. For every foreground voxel, the distance of itself to the nearest voxel that does not belong to the same instance (that is, the shortest distance to a voxel in the other instance, denoted by dashed-line arrows in FIG. 5) is determined. This loss function compares this distance with a ground-truth centroid distance (triple-dash-dot line arrows in FIG. 5) and penalizes the difference. Formally,

$${L}_{repel} = \frac{1}{I} {\sum }_{i = 1}^{I} \frac{1}{{P}_{i}} {\sum }_{p = 1}^{{P}_{i}} max \{ 0 , {min}_{j ∀ [ 1 , I ] ∩ j \neq i} ‖ {\overline{C}}_{g t i} - {\overline{C}}_{g t j} ‖ - {min}_{q ∀ [ 1 , {P}_{j} ] , j ∀ [ 1 , I ] ∩ j \neq i} ‖ {C}_{fi , p} - {C}_{fj , q} ‖ \} ,$$

where I is the number of instances, Pᵢ Pⱼ is the number of voxels in instance i and instance j respectively, C_{f i,p} is the final centroid prediction after sparse multi-directional attention for voxel p in instance I, C_{f i,p} is the final centroid prediction after sparse multi-directional attention for voxel p in instance I, and C̅_{gt i} is the ground truth entroid for instance i. Essentially, this loss function ensures the coordinate of each voxel is away from its adjacent instance.

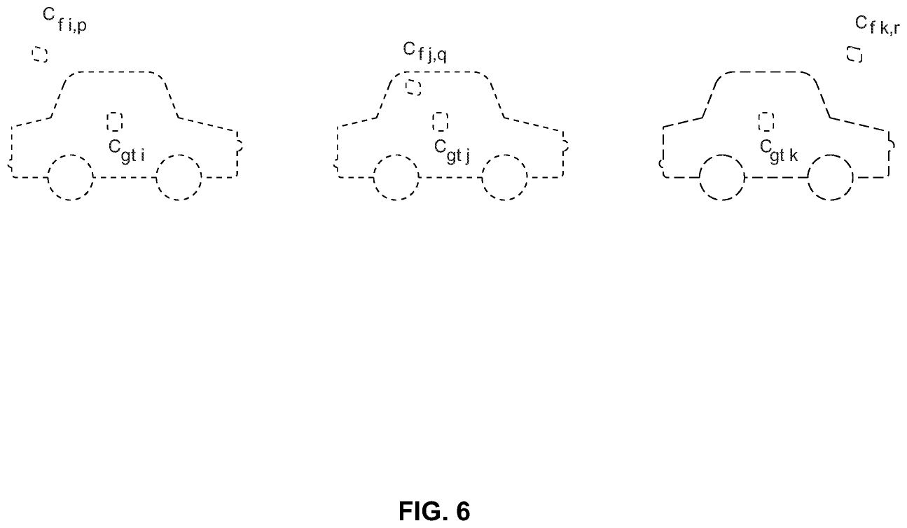

FIG. 6 shows a scenario where centroid-aware repel loss is zero.

The inverse hash map, H, is used to update the coordinate of every foreground point with C_{f} (184).

The clustering sub-module 68 is configured to run a clustering algorithm, such as BFS, on C_{F} to segment the foreground into n instances (185).

The foreground point cloud in BEV, C_{bev}, is processed by sparse multi-directional attention to ensure the points are more aggregated towards the object centers; thus, a simple and fast clustering algorithm like BFS can easily differentiate each cluster. Further, for every valid entry in C_{bev}, the center of mass of its neighborhood in five directions is obtained using Eq.4, denoted as CW, CE, CN, CS, and CC.

$${C}_{f , u} = \frac{1}{{n}_{u}} {\sum }_{i ∈ Ω ( K )} {C}_{bev , u + 1} \cdot {O}_{u + 1} \qquad ( 4 )$$

where Ω(K) is a set of 2D indices for each neighborhood sampling region with size K and n is the number of valid entries in the neighborhood acting as a normalization factor, formally, nᵤ=Σ_{i∈Ω}Oᵤ₊₁. The multi-directional neighbor sampling is denoted as Ω_{W}(K): {(0,i)|∀i ∈[−K,0]},Ω_{E}(K): {(0,i)|∀i ∈[0,K]},Ω_{N}(K): {(i,0)|∀i ∈[−K,0]}, Ω_{S}(K): {(i,0)|∀i ∈[0,K]}. The foreground point cloud at location u in BEV representation after being processed by sparse multi-directional attention and clustering module 60, C_{f,u}, can be expressed as

C_{f,u}=C_{all,u}×σ(MLP(H_{f,u})) (5)

where C_{all,u} ∈ [symbol] ^{2×5}=cat(C_{w,u},C_{E,u},C_{N,u},C_{S,u},C_{C,u}) are the concatenated xy centers of mass from applying kernels in five directions at location πᵤ ∈ [symbol] ⁵ are the attention weights computed using the MLP from the foreground features at location u of the BEV map; σ denotes the softmax operator to ensure the attention weights in all directions summing up to 1, and x is matrix multiplication. Essentially, C_{f} is the final location of the foreground point cloud in BEV, shifted towards its neighboring points after receiving the directional guidance from the network.

The main purpose of the SMAC module 60 is not to have an accurate prediction of the object center, but to have each object forming a cluster that could be easily differentiated from others in the 2D BEV space. In order to tackle this problem, a novel centroid-aware repel loss is used to supervise this module.

$${L}_{r e p e l} = \frac{1}{I} {\sum }_{i = 1}^{I} \frac{1}{{P}_{i}} {\sum }_{p = 1}^{{P}_{i}} max \{ 0 , {d}_{i} - {\hat{d}}_{i , p} \} \qquad ( 6 )$$

$${d}_{i} = {min}_{j ∈ \vert 1 , I \vert ∩ j \neq i} {‖ {C}_{gt , i} - {C}_{gt , j} ‖}_{2} \qquad ( 7 )$$

$${\hat{d}}_{i , p} = {min}_{j ∈ \vert 1 , I \vert ∩ j \neq i} {‖ {C}_{f , ( i , p )} - {C}_{f , ( j , q )} ‖}_{2} \qquad ( 8 )$$

where I is the total number of instances, Pᵢ is the number of occupied points in C_{bev} for instance i, C_{f,(i,p)}∈ [symbol] ² is the final 2D position after SMAC at point p that belongs to instance i, and c_{gt,i} ∈ [symbol] ² is the ground truth 2D centroid of instance i. Essentially, \hat{d} represents the closest distance from itself (final shifted position) to any other point from other objects, and d represents the distance between the ground-truth centroid of current object to the other closest instance. This loss term penalizes if the ground truth distance, d is larger than \hat{d}, meaning the network still needs to learn such that each foreground cluster is repelled from others.

Further, an additional loss term is used to enforce the variance of each cluster is minimized:

$${L}_{attract} = \frac{1}{I} {\sum }_{i = 1}^{I} \frac{1}{{P}_{i}} {\sum }_{p = 1}^{{P}_{i}} {‖ {C}_{f , ( i , p )} - {\overline{C}}_{f , i} ‖}_{2} \qquad ( 9 )$$

where C̅_{f,i} is the average of the all the point locations in BEV after processing by the sparse multi-directional attention and clustering module 60 for instance. i and the rest of the terms are defined as the same as in Eq.6. Three loss terms are employed to supervise the semantic segmentation, similar to Gerdzhev and L2 regression loss to supervise the center offset from the instance decoder. Thus, the total loss is the weighted combination illustrated as follows:

Lₜₒₜₐₗ=β_{wce}+βₗₛLₗₛ+βₜᵥLₜᵥ+βₗ₂Lₗ₂+βᵣₑₚₑₗLᵣₑₚₑₗ+β_{attract}L_{attract} (10)

In an alternative embodiment, the sparse multi-directional attention sub-module 60 may be a 3D sparse multi-attention directional attention sub-module. In this alternative embodiment, a coordinate of a point in the received point could will include a z coordinate in addition to x and y coordinates, and the filtered foreground points are mapped to voxels of defined finite dimensions along the x, y, and z axes. The filtered point cloud c has original coordinates xyz. F is its corresponding features from the instance decoder. C has a shape of (N, 3), and F has a shape of (N, f) where N is the number of foreground points and f is the number of features. The foreground point coordinate, Cₛ, is obtained when applying the learned 3D offset from the instance decoder 44 to C. In particular, Cₛ=C−0. Then, the foreground point cloud is voxelized with voxel size of (dₓ,d_{y},d_{z}) using its learned coordinate, Cₛ. dₓ, d_{y} and d_{z} are the grid size in x, y and z axis respectively. At the same time, the inverse mapping is recorded to devoxelize as hash map H. Voxelized point cloud contains coordinates C_{D} and features F_{D} which are the mean coordinates and features of the points within the grid. In particular, C_{D} and F_{D} have a shape of (M, 3) and (M, 3) respectively, where M is the number of voxels and C is the number of features.

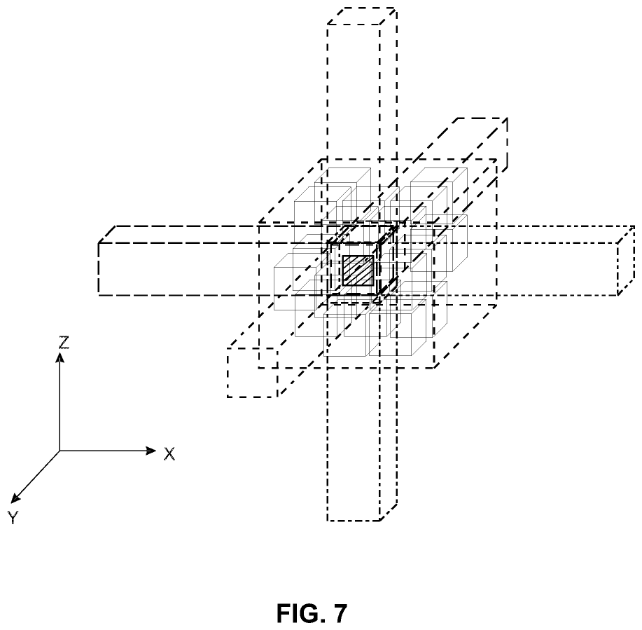

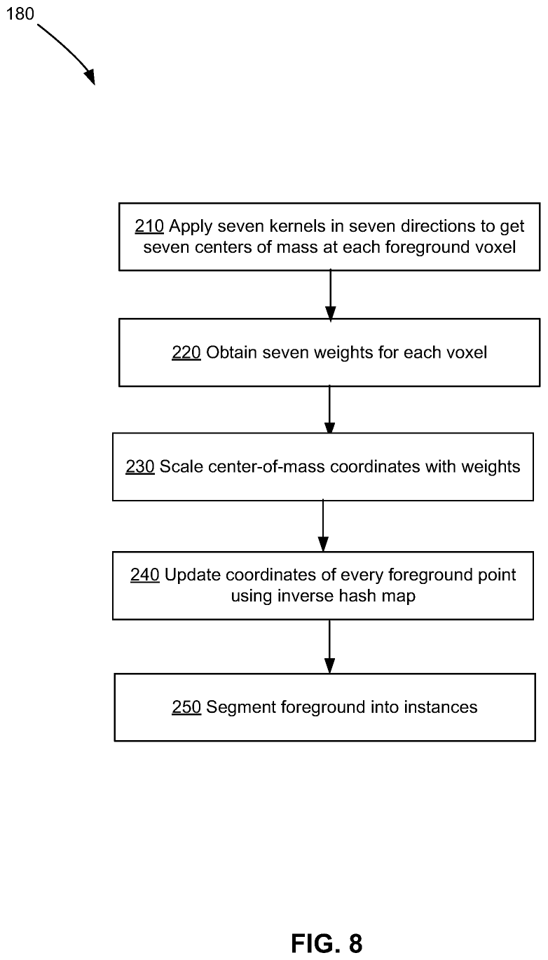

Thus, there are in total seven centers of mass in seven directions with two extra from the z axis as shown in FIG. 7. In this embodiment, the sparse multi-directional attention module 60 performs the following steps at 180 shown in FIG. 8.

At each foreground voxel, the sparse multi-directional attention and clustering module 60 applies seven kernels in seven directions to get seven centers of mass [symbol] _{LEFT}, [symbol] _{RIGHT}, [symbol] _{UP}, [symbol] _{DOWN}, [symbol] _{FRONT}, [symbol] _{BACK}, and [symbol] _{CENTRE} as shown in FIG. 7 (210). The left center of mass is computed as

$${\vec{C}}_{LEFT} [ i , j , k ] = \frac{1}{{P}_{LEFT , ijk}} {\sum }_{( u , v , w ) {ϵΩ}_{LEFT}} {C}_{D} [ i + u , j + v , k + w ]$$

and the kernels extend to
Ω_{LEFT}: {(0,0,0), (0, −1,0), . . . , (0,−K ,0)}
Ω_{RIGHT}: {(0,0,0), (0,1,0), . . . , (0,K,0)}
Ω_{UP}: {(0,0,0), (−1,0,0), . . . , (−K,0,0)}
Ω_{DOWN}: {(0,0,0), (1,0,0), . . . , (K,0,0)}
Ω_{FRONT}: {(0,0,0), (0,0,1), . . . , (0, 0,K)}
Ω_{BACK}: {(0,0,0), (0,0,−1), . . . , (0, 0,−K)}

Ω_{CENTRE}: v³(k), list of offsets in 3-dimensional hypercube centered at the origin, where P_{LEFT,ijk} is number of occupied voxels within the left neighbourhood of voxel (i,j,k).

Seven weights are then obtained from the MLP for each voxel from the seven centers of mass and the features for each voxel in the kernel regions (220). The MLP shifts foreground points such that foregrounds points of the same instance object are close to each other and away from other instances. The seven weights are:
wleft, wright, wup, wdown, wfront, wback, wcentre:=MLP (FD) wleft, wright, wup, wdown, wfront, wback, wcentre:=softmax(wleft, wright, wup, wdown, wfront, wback, wcentre)
   The coordinates for the seven centers of mass are scaled with the corresponding weights to provide a center of mass for the voxel (230). In particular,
[symbol] _{f}:=wleft* [symbol] _{LEFT}+wright* [symbol] _{RIGHT}+wup* [symbol] _{UP}+wdown* [symbol] _{DOWN}+wfront* [symbol] _{FRONT}+wback* [symbol] _{BACK}+wcentre* [symbol] _{CENTRE}.
   The inverse hash map, H, is used to update the coordinate of every foreground point with C_{f} (240). Note that the weights generated by the MLP that are used to derive C_{f} train the MLP with supervision using a centroid-aware repel loss. Then the clustering sub-module 68 runs a clustering algorithm, such as BFS, on C_{F} to segment the foreground into n instances (250).

The approach described here utilizes a learnable sparse multi-directional attention to significantly reduce the runtime of clustering to segment multi-scale foreground instances. Thus, it provides an efficient real-time deployable clustering-based approach, which removes the complex proposal network to segment instances.

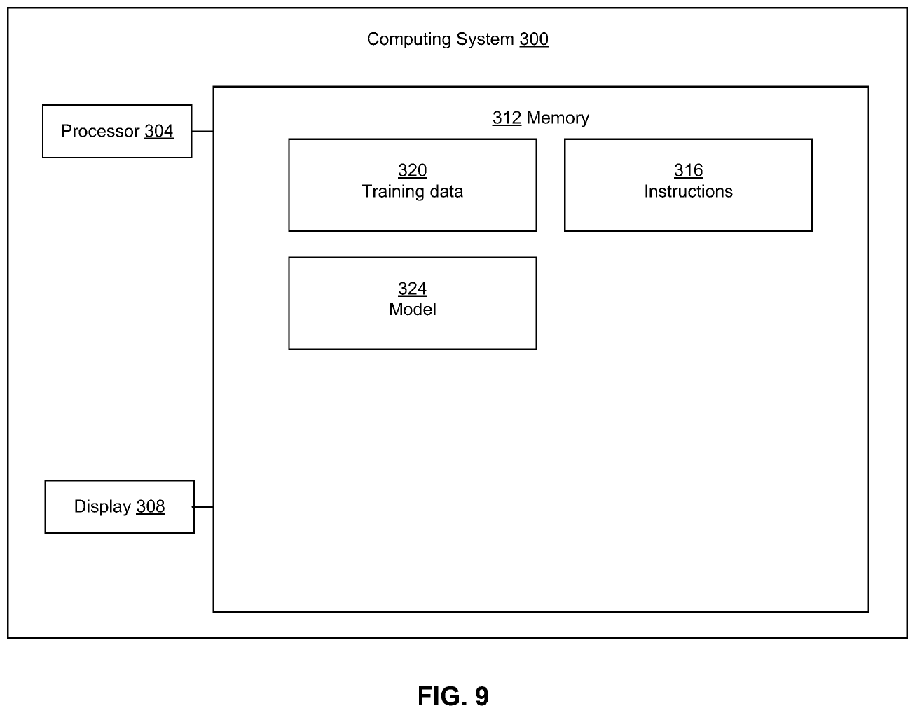

FIG. 9 shows various physical and logical components of an exemplary computing system 300 for panoptic segmentation of point clouds in accordance with an embodiment of the present disclosure. Although an example embodiment of the computing system 300 is shown and discussed below, other embodiments may be used to implement examples disclosed herein, which may include components different from those shown. Although FIG. 9 shows a single instance of each component of the computing system 300, there may be multiple instances of each component shown. The example computing system 300 may be part of, or connected to, a simultaneous localization and mapping (SLAM) system, such as for autonomous or semi-autonomous vehicles.

The computing system 300 includes one or more processors 304, such as a central processing unit, a microprocessor, an application-specific integrated circuit (ASIC), a field-programmable gate array (FPGA), a dedicated logic circuitry, a tensor processing unit, a neural processing unit, a dedicated artificial intelligence processing unit, or combinations thereof. The one or more processors 304 may collectively be referred to as a processor 304. The computing system 300 may include a display 308 for outputting data and/or information in some applications, but may not in some other applications.

The computing system 300 includes one or more non-transitory memories 312 (collectively referred to as “memory 312”), which may include a volatile or non-volatile memory (e.g., a flash memory, a random access memory (RAM), and/or a read-only memory (ROM)). The non-transitory memory 312 may store machine-executable instructions for execution by the processor 304. A set of machine-executable instructions 316 defining a training and application process for the clustering-based panoptic segmentation system 20 (described herein) is shown stored in the memory 312, which may be executed by the processor 304 to perform the steps of the methods for training and using the system 20 for clustering-based panoptic segmentation described herein. The memory 312 may include other machine-executable instructions for execution by the processor 304, such as machine-executable instructions for implementing an operating system and other applications or functions.

The memory 312 stores the training database 320 that includes point cloud data used to train the system 20 for clustering-based panoptic segmentation as well as ground-truth centroids for the point cloud data as described herein.

A neural network, and, in particular, the MLP 324, for panoptic segmentation of point clouds is used to generate weights for the voxels in the kernel regions and trained as described herein is also stored in the memory 312.

In some examples, the computing system 300 may also include one or more electronic storage units (not shown), such as a solid state drive, a hard disk drive, a magnetic disk drive and/or an optical disk drive. In some examples, one or more datasets and/or modules may be provided by an external memory (e.g., an external drive in wired or wireless communication with the computing system 300) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The storage units and/or external memory may be used in conjunction with the memory 312 to implement data storage, retrieval, and caching functions of the computing system 300.

The components of the computing system 300 may communicate with each other via a bus, for example. In some embodiments, the computing system 300 is a distributed computing system and may include multiple computing devices in communication with each other over a network, as well as optionally one or more additional components. The various operations described herein may be performed by different computing devices of a distributed system in some embodiments. In some embodiments, the computing system 300 is a virtual machine provided by a cloud computing platform.

Although the components for both training and using the audio-visual transformation network 20 are shown as part of the computing system 300, it will be understood that separate computing devices can be used for training and using the system 20 for clustering-based panoptic segmentation.

The steps (also referred to as operations) in the flowcharts and drawings described herein are for purposes of example only. There may be many variations to these steps/operations without departing from the teachings of the present disclosure. For instance, the steps may be performed in a differing order, or steps may be added, deleted, or modified, as appropriate.

In other embodiments, the same approach described herein can be employed for other modalities.

Experimentation was performed to test the performance of the approach described herein. The results indicated that the approach provides a good balance between run-time and accuracy. Using the SemanticKITTI and nuScene datasets, the disclosed approach improved the mean IoU by 3.3% compared to prior approaches.

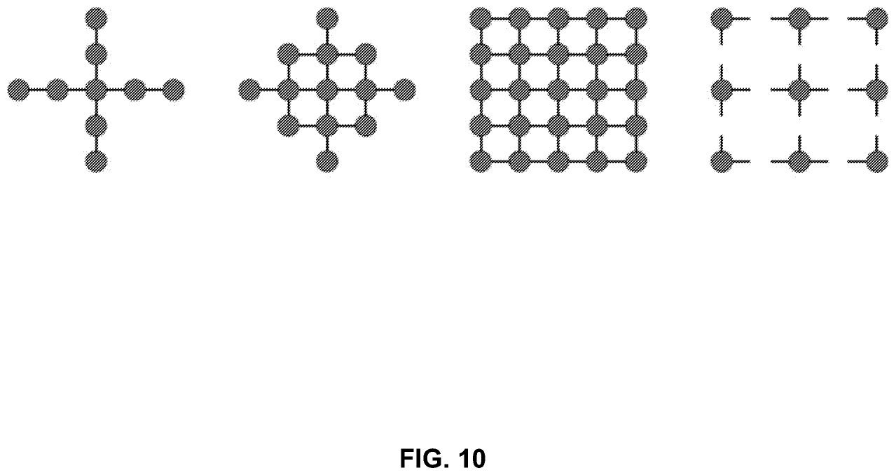

Further, the effectiveness of convolutions with CLSA on the semantic segmentation tasks with various kernel shapes as illustrated in FIG. 10 was tested. More granular grids with kernel sizes of 5 or 7 appear to yield better results using the approach described herein.

General

Through the descriptions of the preceding embodiments, the present invention may be implemented by using hardware only, or by using software and a necessary universal hardware platform, or by a combination of hardware and software. The coding of software for carrying out the above-described methods described is within the scope of a person of ordinary skill in the art having regard to the present disclosure. Based on such understandings, the technical solution of the present invention may be embodied in the form of a software product. The software product may be stored in a non-volatile or non-transitory storage medium, which can be an optical storage medium, flash drive or hard disk. The software product includes a number of instructions that enable a computing device (personal computer, server, or network device) to execute the methods provided in the embodiments of the present disclosure.

All values and sub-ranges within disclosed ranges are also disclosed. Also, although the systems, devices and processes disclosed and shown herein may comprise a specific plurality of elements, the systems, devices and assemblies may be modified to comprise additional or fewer of such elements. Although several example embodiments are described herein, modifications, adaptations, and other implementations are possible. For example, substitutions, additions, or modifications may be made to the elements illustrated in the drawings, and the example methods described herein may be modified by substituting, reordering, or adding steps to the disclosed methods.

Features from one or more of the above-described embodiments may be selected to create alternate embodiments comprised of a sub-combination of features which may not be explicitly described above. In addition, features from one or more of the above-described embodiments may be selected and combined to create alternate embodiments comprised of a combination of features which may not be explicitly described above. Features suitable for such combinations and sub-combinations would be readily apparent to persons skilled in the art upon review of the present disclosure as a whole.

In addition, numerous specific details are set forth to provide a thorough understanding of the example embodiments described herein. It will, however, be understood by those of ordinary skill in the art that the example embodiments described herein may be practiced without these specific details. Furthermore, well-known methods, procedures, and elements have not been described in detail so as not to obscure the example embodiments described herein. The subject matter described herein and in the recited claims intends to cover and embrace all suitable changes in technology.

Although the present invention and its advantages have been described in detail, it should be understood that various changes, substitutions and alterations can be made herein without departing from the invention as defined by the appended claims.

The present invention may be embodied in other specific forms without departing from the subject matter of the claims. The described example embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the embodiments set forth in the examples, but should be given the broadest interpretation consistent with the description as a whole.

What is claimed is:

1. A computer-implemented method for clustering-based panoptic segmentation of point clouds, comprising:
extracting features of a point cloud that includes a plurality of points;
identifying clusters of the plurality of points corresponding to objects from the features of the point cloud frame; and
selectively shifting a subset of the plurality of points using the features and the clusters of the plurality of points via a neural network that is trained to recognize a subset of points of objects that are closer to points of other objects than a distance between centroids of the corresponding objects and shift the subset of points away from the other objects.

2. The computer-implemented method of claim 1, further comprising:
mapping the plurality of points in the clusters into voxels;
for each voxel in which points of the clusters are located, determining a center of mass of at least regions extending from the voxel in each direction along at least two axes; and
wherein the selectively shifting includes processing the center of mass and features of each region to identify a center of mass for the voxel.

3. The computer-implemented method of claim 2, wherein a neighborhood region of voxels within a range of the voxel is also used to determine the center of mass for each voxel.

4. The computer-implemented method of claim 2, wherein the extracting features includes encoding the point cloud, and wherein the identifying includes decoding the encoded point cloud and, for every point in the clusters of the plurality of points, predicting an offset to shift the point to a centroid of the object.

5. The computer-implemented method of claim 4, wherein, for each voxel in which points of the clusters are located, the neural network generates a weight for each region that is used to scale the center of mass of the region.

6. The computer-implemented method of claim 2, wherein the regions extend from the voxel in each direction along three axes.

7. The computer-implemented method of claim 6, wherein a neighborhood region of voxels within a range of the voxel is also used to determine the center of mass for each voxel.

8. A computing system for panoptic segmentation of point clouds, comprising:
a processor;
a memory storing machine-executable instructions that, when executed by the processor, cause the processor to:
extract features of a point cloud that includes a plurality of points;
identify clusters of the plurality of points corresponding to objects from the features of the point cloud frame; and
selectively shift a subset of the plurality of points using the features and the clusters of the plurality of points via a neural network that is trained to recognize a subset of points of objects that are closer to points of other objects than a distance between centroids of the corresponding objects and shift the subset of points away from the other objects.

9. The computing system of claim 8, wherein the instructions, when executed by the processor, cause the processor to:
map the plurality of points in the clusters into voxels;
for each voxel in which points of the clusters are located, determine a center of mass of at least regions extending from the voxel in each direction along at least two axes; and
wherein the selectively shift includes processing the center of mass and features of each region to identify a center of mass for the voxel.

10. The computing system of claim 9, wherein a neighborhood region of voxels within a range of the voxel is also used to determine the center of mass for each voxel.

11. The computing system of claim 9, wherein, during extraction of the features, the instructions, when executed by the processor, cause the processor to encode the point cloud, and, during the identification of clusters, decode the encoded point cloud and, for every point in the clusters of the plurality of points, predict an offset to shift the point to a centroid of the object.

12. The computing system of claim 11, wherein, for each voxel in which points of the clusters are located, the neural network generates a weight for each region that is used to scale the center of mass of the region.

13. The computing system of claim 9, wherein the regions extend from the voxel in each direction along three axes.

14. The computing system of claim 13, wherein a neighborhood region of voxels within a range of the voxel is also used to determine the center of mass for each voxel.

15. A method for training a system for panoptic segmentation of point clouds, comprising:
extracting features of a point cloud that includes a plurality of points;
identifying clusters of the plurality of points corresponding to objects from the features of the point cloud frame; and
selectively shifting a subset of the plurality of points using the features and the clusters of the plurality of points via a neural network that is trained via supervision to recognize a subset of points of objects that are closer to points of other objects than a distance between ground-truth centroids of the corresponding objects and shift the subset of points away from the other objects.

16. The method of claim 15, further comprising:
mapping the plurality of points in the clusters into voxels;
for each voxel in which points of the clusters are located, determining a center of mass of at least regions extending from the voxel in each direction along at least two axes; and
wherein the selectively shifting includes processing the center of mass and features of each region to identify a center of mass for the voxel.

17. The method of claim 16, wherein a neighborhood region of voxels within a range of the voxel is also used to determine the center of mass for each voxel.

18. The method of claim 16, wherein the extracting features includes encoding the point cloud, and wherein the identifying includes decoding the encoded point cloud and, for every point in the clusters of the plurality of points, predicting an offset to shift the point to a centroid of the object.

19. The method of claim 18, wherein, for each voxel in which points of the clusters are located, the neural network generates a weight for each region that is used to scale the center of mass of the region.

20. The method of claim 16, wherein the regions extend from the voxel in each direction along three axes.
